(19) United States
(12) Patent Application Publication
(10) Pub. No.: US 2025/0287188 A1
(43) Pub. Date: Sep. 11, 2025

(54) INTER-VEHICLE SAFETY COMMUNICATIONS SYSTEM AND METHOD OF USE

(71) Applicant: Ross Blankenship, Edwards, CO (US)

(72) Inventor: Ross Blankenship, Edwards, CO (US)

(21) Appl. No.: 18/600,970

(22) Filed: Mar. 11, 2024

(51) Int. Cl. H04W 4/46; G06V 20/58; G06V 20/62; G10L 15/26; H04N 7/18

(52) U.S. Cl. CPC H04W 4/46; G06V 20/58; G06V 20/625; G10L 15/26; H04N 7/183

(57) ABSTRACT

The invention is an inter-vehicular safety communications system and method providing a support for sending a safety message to a vehicle and driver that has agreed to receive such messages. Opt-in agreement must be established before any messages are prepared and conveyed. Wherein opt-in agreement is verified, the system supports the sending and receiving of such safety messages between assenting drivers in both voice and text format. Operating the system is minimally distracting and essentially hands free.

### TECHNICAL FIELD

The invention is a system and method of use that supports inter-vehicle communications.

### BACKGROUND OF INVENTION

There are times where a driver in one vehicle sees a problem with a second vehicle and wants to alert the second vehicle's driver about the problem. During daytime, one might flash headlights on and off, or tap the horn, to get another driver's attention. In such cases, the first driver may try to pantomime the nature of a problem to the other driver. Or, the first driver may signal for both vehicles to pull off to the side. In any case, there are no widespread protocols for such communications attempts.

When a patrol vehicle wants to pull a driver over, they may use roof-top flashing lights, a siren burst, or an amplified voice command. But where regular vehicles are driving, there is currently no system in place to support real-time safety-oriented communications.

### BRIEF DESCRIPTION OF INVENTION

The invention herein disclosed and claimed is a system and method of use that supports safety-related inter-vehicle communications. If the drivers of both vehicles have cellular phones with hands-free interfaces, and the drivers know each other's cellular phone numbers, then a first driver could simply call a second driver and describe the apparent safety problem. But, that communications infrastructure requires that both drivers know each other.

There are well-known wireless communications technologies that could support the exchange of voice or text messages between two drivers. However, again, both drivers will have had to agree beforehand and exchange information in order to establish a one-to-one communications interface.

The invention disclosed makes use of existing wireless communications means and couples it with a system and process for requesting to send a message, and upon receiving an acceptance notification, then sending a voice, text or both from one driver to the other driver.

Each driver would first have had to acquire and enable an application that supported this exchange of messages, and each driver would have had to register the vehicle so that a driver wishing to send a message could only do so if the other driver has opted in for receiving such messages. And, even if both parties have opted in, a driver wishing to send a message must first receive an acceptance notification before the communications path is established and one driver is then allowed to proceed with messaging the other driver.

The system supporting this communications capability may be a separate device affixed, for example, to a rear-view mirror mounting. It may also be built into the automobiles safety and entertainment system.

In sum, when a first driver wishes to notify a second driver about something, the first driver's system captures the second driver's license-plate data, or a QR code from a decal on a rear bumper, and determines that the second driver has opted in to receive such messages. Clearly, in order to facilitate the process, the car wishing to send the message must be behind the car to receive the message thereby allowing the capture of license-plate and/or QR code data. In such case, the vehicle to receive the message is identified as the “leading” vehicle, implying the juxtaposition of two cars, in the same traffic lane, one in front of the other.

If the second driver (of the leading car) has opted in, the first driver's system will send a message request that is directed specifically to the other vehicle's system. The second driver hears/reads a voice/text request message and responds by voice. If the second driver accepts the request, the second driver's system then sends an acceptance notification to the first driver's system.

Upon receipt of the acceptance message, the first driver hears/reads a voice/text acceptance message. Then, the first driver says the message which is then digitized and transmitted to the second driver. The second driver hears/reads the voice/text of the first driver's message.

If the second driver wishes to respond, the process repeats in reverse. The second driver's system sends a response message request, and if the first driver agrees, a response-acceptance message is sent to the second driver's system. When the second driver hears/sees the voice/text response acceptance message, the second driver says the response which ultimately is sent to the first driver's system, who then hears/see the voice/text response.

Neither driver has to divert his attention from the road, and driving, and the communications proceeds without either driver having to pull over. Consequently, a safety message is passed between the two drivers, in their vehicles, with minimal disruption.

### BRIEF DESCRIPTION OF DRAWINGS

FIG. 1 shows a first vehicle and its driver sending a request message to a second vehicle and its driver.

FIG. 2 illustrates an embodiment of the system.

FIG. 3 shows how the embodiment of FIG. 2 is divided into subsystems within the vehicle and those that are located outside the vehicle.

FIG. 4 is an example method flow showing the steps for requesting and sending a message.

FIG. 5 is an example of the method of FIG. 4 further supporting set up and response message conveyance.

### DETAILED DESCRIPTION OF INVENTION

There are protocols that support one driver signaling a second driver of a desire to pass. Traffic patrol personnel and their vehicles have systems and protocols for alerting drivers to move aside to let them pass, or to pull over.

Two drivers who know one another, and who know one another's cellphone numbers, could call while driving to exchange messages.

But, there is no supporting system or protocol for one driver passing a message to a second driver. Makeshift protocols, such a horn beeping and light flashing, may succeed in having both drivers pull over. But, it may simply be written off as one driver annoying another.

If one driver sees a vehicle ahead with what looks like fuel dripping out, or a significantly underinflated tire, or a non-working rear brake light, it would be helpful and improve safety to let the other driver know there is a problem.

The inter-vehicle safety communications system and method is intended to provide a way for drivers to safely pass along safety-related messages.

First, a driver should be able to allow or not allow such messages. Thus, even if a vehicle is equipped with the supporting subsystems for creating and sending such messages, every driver should be able to opt in or out.

In the case where a driver wishes to opt in to receiving safety messages from another driver, that driver would register his vehicle using its license-plate data or a QR code on a decal to be attached to a rear bumper. If that driver has not so registered, his system will not be operative to receive message requests or messages.

Where a driver has registered his vehicle, any request by another driver to send a message must be accepted before that message can be sent and received. So, an opt-in status must be accepted each time a message request has been received or no message is then sent.

If a driver receives a message request, and accepts it, the other driver can then simply speak the message, which is then processed and transmitted wirelessly to the first driver. The first driver's system will display a text of the message and reproduce its voice message.

Having received a safety message, if the first driver does not wish to respond, then the process ends. If the first driver wishes to respond, his system will send the other driver a response request. That other driver can accept the request, in which case the process simply goes in reverse with the first driver now speaking his response and the second driver hearing/seeing a voice and text response message.

The description and drawing references are intended to provide more detail about the invention system and method of use. It is exemplary and should not be read as limiting the scope of claims to this specific example.

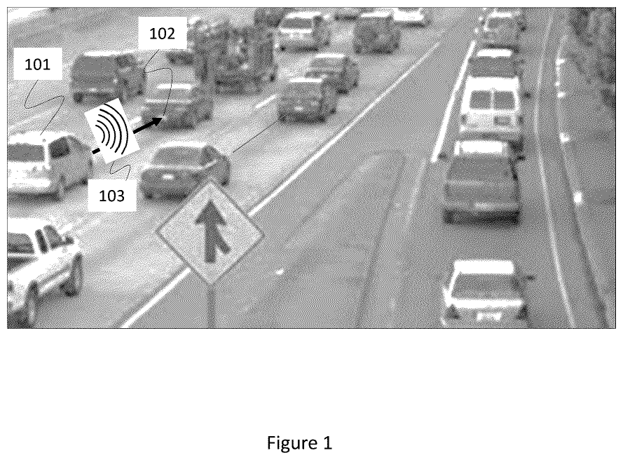

As shown in FIG. 1, the driver of vehicle 101 wants to alert the driver of the leading vehicle 102 to an apparent problem. The driver in vehicle 101 says “message request,” and his system, its subsystems and its one or more programs proceed to first capture the license-plate data and/or QR code data from the rear of vehicle 102 and compare it to a database of opt-in vehicles and their respective license-plate or QR code data. Assuming vehicle 102 has opted in, vehicle 101's system sends a wireless message comprising the message request to vehicle 101's system.

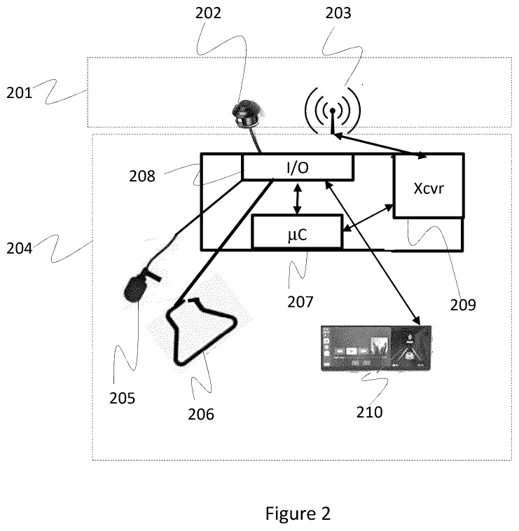

FIG. 2 is an exemplary block diagram depicting the system in vehicle 101 and its subsystems. An electronic subsystem (204) comprises an input/output (I/O) subsystem (208), a microcontroller (comprising a processor, read/write memory, and read-only memory with one or more control programs), and a wireless transceiver operative to send and receive wirelessly conveyed messaging. A camera (202) and antenna (203) interface with the I/O subsystem and transceiver subsystem, respectively. A microphone (205), audio transducer (206), and display screen (210) interface with the I/O subsystem. The microphone is operative to receive spoken analog input and in combination with the I/O and microcontroller subsystems to digitize the voice analog input into equivalent digital format. The transducer is operative to convert analog audio signals into equivalent audible sound. And, the display subsystem is operative to convert digitized messages into equivalent displayed text messages. The system is divided into subsystems that are contained within a vehicle (204) and subsystems located outside the vehicle (201).

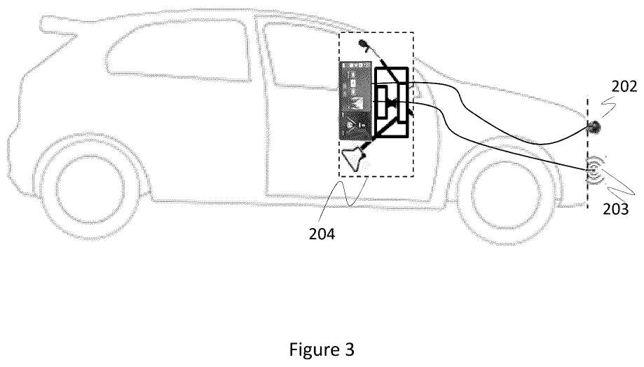

FIG. 3 depicts the portion of the system located inside the vehicle (204) and that located outside the vehicle (201). The interface between the subsystems inside the vehicle, and those outside the vehicle, may be conductive (shown) or wireless (not shown).

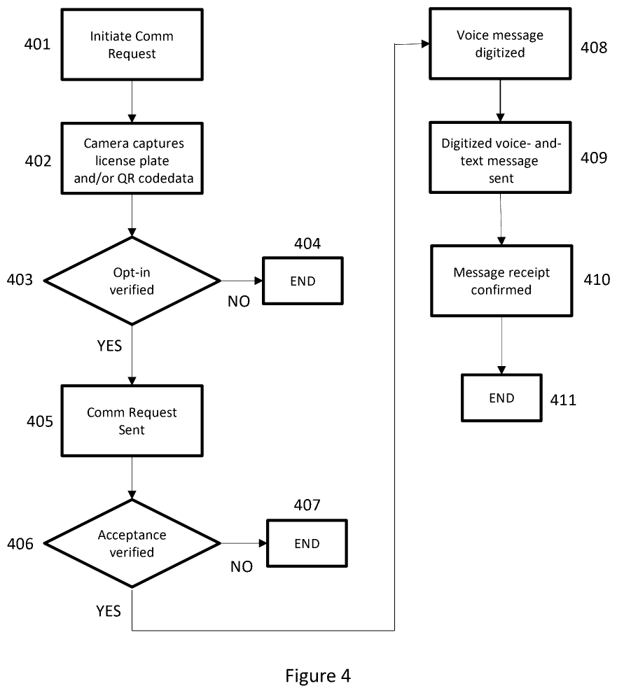

FIG. 4 is a flow diagram illustrating a method-of-use sequence of method steps for requesting and conveying a safety message from one vehicle to a second vehicle. When the driver in a first vehicle says “message request” (401) the system captures license-plate or QR code data (402). The captured data is compared to a database of opt-in license-plate and/or QR code data to verify (403) that the second vehicle has opted in to receive such messages. If not verified, the process ends (404) and no message is prepared and sent. If verified, a voice and text message request is sent, wirelessly, to the second vehicle (405). The driver of the second vehicle will hear and see the message request and can say “accepted” or “not accepted.” If not accepted, the process ends (407). If accepted, the first vehicle driver states the message, such as “your left brake light is not working,” and the system in the first vehicle converts the spoken message into a digitized equivalent (408). The digitized message is then sent wirelessly (409) and the second vehicle's system will confirm receipt by sending a confirmation back to the first vehicle (410). At that point, this process ends (411).

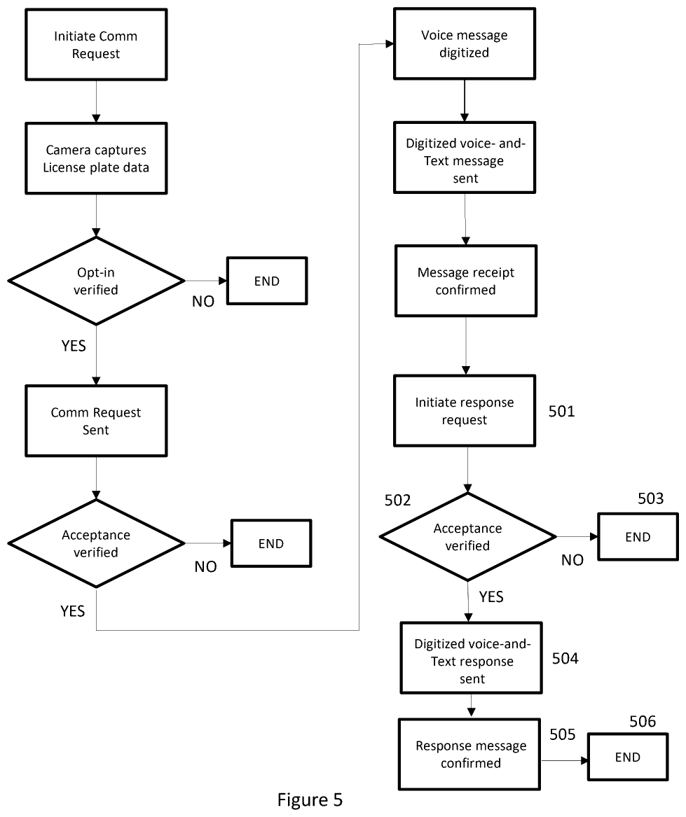

FIG. 5 illustrates an exemplary method-of-use step flow wherein the method-flow of FIG. 4 is augmented to add a process for responding to the message sent by the first vehicle's driver. Here, instead of ending with message receipt confirmation (FIG. 4, 410), the driver of the second vehicle says “response request” (501) and a response request message is conveyed wirelessly from the second vehicle's system to the first vehicle's system. The first vehicle's driver can say “accepted” or “not accepted.” If accepted, the second vehicle's driver speaks the response message, such as “thank you very much.” The system in the second vehicle converts the voice message into its digitized equivalent and conveys it wirelessly to the first vehicle. The first vehicle's driver hears and sees the response message and a confirmation is sent to the second vehicle (505). Then the process ends (506).

Note this system and method of use provides either a single-message conveyance, or a message-conveyance-and-response. It is not intended as a system to support an uninterrupted conversation between two drivers. By invoking the system, repetitively, one can send and receive a set of related messages, much as occurs with, say, email messaging. But the primary objective is to efficiently enable and support one or a few safety-related, back-and-forth messages, rather than a conversation.

The subsystems comprising FIG. 2, 204 are shown as separate functional blocks implying individual components. It may also be implemented as a modular or monolithic component. It may also be implemented at programs integrated with an existing automotive system, such as an entertainment or vehicle control system.

The flow diagrams included, again, are exemplary. The steps and flow may vary so long as the overall objectives are preserved-opt-in message receipt. voice/text message presentation, and hands-free operation. The system and method-of-use is meant to eliminate or limit any driver distractions. Hence, there are no buttons to press to invoke any process step.

What is claimed is:

1. An inter-vehicle communication system comprising:
an electronic camera;
a control subsystem;
a microphone;
a display screen;
a transducer; and
an antenna.

2. A claim as in claim 1 wherein:
the electronic camera is operative to capture images of a leading vehicle, that is, a vehicle ahead and in the same lane;
the images comprise:
a license plate; and
a QR code.

3. A claim as in claim 1 wherein:
the control subsystem comprises:
an input/output subsystem;
a microcontroller subsystem;
a wireless transceiver subsystem; and
at least one program.

4. A claim as in claim 3 wherein:
the input/output subsystem is operative to receive images from the electronic camera and convey them to the microcontroller subsystem;
the input/output subsystem is operative to convey data to, and receive data from, the microcontroller subsystem;
the input/output subsystem is operative to receive spoken signals from the microphone and convert the spoken signals into digital equivalent signals;
the input/output subsystem is operative to receive digitized audio signals from the microcontroller and to convert the digitized audio signals into analog audio signals and convey the analog audio signals to the transducer, and convert the digitized audio signals into a text signal and convey the text signal to a display screen; and
the input/output subsystem is operative to convey outgoing message signals to the wireless transceiver.

5. A claim as in claim 3 wherein:
the at least one program is operative to distill license-plate data from the electronic camera images and compare them to a database of opt-in license plate data;
the at least one program is operative to prepare a communication-request message and convey the communication-request message to the wireless transceiver subsystem for transmission;
the at least one program is operative to receive a communication acceptance message from the wireless transceiver subsystem;
the at least one program is operative to control preparation and conveyance of a spoken message, received and digitized by the input/output subsystem and then conveyed to the microcontroller, and convey the digitized spoken message to the wireless transceiver subsystem for transmission; and
the at least one program is operative to convert the digitized voice messages into text messages for display on a display screen.

6. A claim as in claim 5 further comprising:
the at least one program is operative to distill QR code data from the electronic camera images and compare them to a database of opt-in QR code data.

7. A claim as in claim 5 wherein:
the at least one program is operative to receive a response-request message, convert it to an audio-signal message, and convey it to the input/output subsystem for conveyance to the transducer;
the at least one program is operative to receive a spoken acceptance message conveyed by the microphone to the input/output subsystem, then digitized and conveyed to the microcontroller subsystem; and
the at least one program is operative to control receipt of a response message conveyed by the wireless transceiver subsystem, convert it to an analog audio signal and convey it to the input/output subsystem for conveyance to the loudspeaker, and to convert the audio signal into a text signal for display on the display screen.

8. A method of use comprising:
determining if a leading vehicle's license-plate data is included in an opt-in database;
determining if the leading vehicle's QR code decal data is included in an opt-in database;
sending a communication-request message, wirelessly, if the leading vehicle is in an opt-in database, and awaiting an acceptance message; then
ending a message attempt if no acceptance received; or
sending a message to the leading vehicle if acceptance received.

9. A method as in claim 8 further comprising:
receiving a response-message request from the leading vehicle;
deciding whether to accept a response message; then
if no acceptance, ending a communication session; or
if accepted, receiving a response message from the leading vehicle, then ending a communication session.
